(19) United States
(12) Patent Application Publication
(10) Pub. No.: US 2007/0211251 A1
(43) Pub. Date: Sep. 13, 2007

(54) DETECTING BACTERIA IN FLUIDS

(76) Inventor: Amnon WEISCHSELBAUM, Haifa (IL)

Correspondence Address: YORAM TSIVION, P.O. BOX 1307, PARDES HANNA, 37111, IL

(21) Appl. No.: 11/573,788

(22) PCT Filed: Aug. 16, 2005
(86) PCT No.: PCT/IL05/00884

§ 371 Date: Feb. 16, 2007

Related U.S. Application Data
(60) Provisional application No. 60/601,644, filed on Aug. 16, 2004.

(51) Int. Cl. G01N 21/00

(52) U.S. Cl. 356/338

(57) ABSTRACT

A method for the detection of bacteria in aqueous fluids in the form of solutions, emulsions and or suspensions, such as drinking water, liquid food and drinks and biological fluids such as urine, spinal and/or amniotic fluids and serums by measurement of light scattering The fluid suspected of containing bacteria is filtered, first to exclude particles of sizes larger than the size of the expected bacteria. Other filtration methods are used in addition to exclude different constituents of the examined fluid. Ion exchange chromatography is such a method. The verification of bacterial contamination and the calculation of its level is performed by matching measured scattering profiles with pre-stored calibrated scattering profiles. A system for carrying out the measurements including cuvette units suited for light scattering measurements is provided.

### FIELD OF THE INVENTION

The present invention relates in general to assaying a body fluid. In particular the present invention relates to optically testing urine for the presence of bacteria, light scattering measurements and filtration.

### BACKGROUND OF THE INVENTION

Aqueous fluids such as solutions, emulsions or suspensions are very common in biological context. These aqueous fluids include potable water for human or animal consumption, liquid food or drinks, urine, amniotic or spinal fluids. Such fluids may be occasionally tested for the presence of bacteria. In clinical microbiology laboratories, a large proportion of analyzed samples are urine samples. Common analyses of urine samples involve microscopy and or culturing, require skilled operators and are time and resource consuming. Therefore, any inexpensive and fast screening method which could obviate a significant amount of expensive and time consuming analytical methods would be beneficial.

Test strips for screening for urinary tract infections are commercially available. Such strips include specific reagents embedded in two distinct pads. One pad contains reagents testing for the presence of leukocyte esterase in the sample. The other pad contains reagents to analyze for nitrite to test for the presence of nitrite-forming bacteria. The detection of bacterial infection is accomplished by matching the colored pads with a gradation of colors in calibrated color charts. European patent application 0320154A1 discloses a method for screening of urine based on a similar approach. The method includes carrying out at least two separate assays on portions of a urine sample mixed with specific reagents. One assay detects the presence of leucocytes and the other the presence of compounds generated by the bacteria such as nitrite. However, both above mentioned methods fail in detecting bacteria that do not generate those products detectable by the specific reagents included. The methods are based on a relatively high bacterial concentration in the sample under test and therefore such screening processes are prone to insufficient sensitivity and relatively low specificity. Furthermore these screening methods are limited to specific populations of patients; they should not be applied for example to infants and or to pregnant women.

### BRIEF DESCRIPTION OF THE DRAWINGS

FIG. 1 is a schematic presentation of a system for detecting bacteria in fluids according to the present invention;

FIG. 2 is a cross sectional view in a schematic cuvette according to a preferred embodiment of the present invention;

FIG. 3 is a cross sectional view in a schematic optical unit of a system for detecting bacteria in fluids according to a preferred embodiment of the present invention;

FIG. 4A is an isometric view of a cuvette unit according to a preferred embodiment of the present invention;

FIG. 4B is an exploded view of the cuvette unit shown in FIG. 4A;

FIG. 4C is a cross sectional view in a cuvette unit according to another preferred embodiment of the present invention;

FIG. 4D is a cross sectional view of the cuvette unit shown in FIG. 4C;

FIG. 5 is a polar plot of a simulated angular distribution of the intensity of light scattered by two particles of different sizes;

FIG. 6A is a graph comparing a simulated versus measured scattering profiles of a typical urine supplemented with bacteria;

FIG. 6B is a graph comparing simulated versus measured contributions of the bacteria and the salt particles to the scattering profiles of FIG. 6A;

FIG. 7A is an angular scattering distribution measured for typical urine sample containing bacteria measuring 10³ CFU/ml;

FIG. 7B is an angular scattering distribution measured for typical urine sample containing 10⁴ CFU/ml;

FIG. 7C is an angular scattering distribution measured for typical urine sample containing 10⁵ CFU/ml;

FIG. 7D is an angular scattering distribution measured for typical urine sample containing 10⁶ CFU/ml;

FIG. 8 is a graph comparing measured versus fitted scattering profiles computed for the urine samples as shown in FIGS. 7A-7D respectively;

FIG. 9 is a graph comparing measured versus fitted scattering profiles of an exemplary urine sample containing bacteria

### DETAILED DESCRIPTION OF THE PRESENT INVENTION

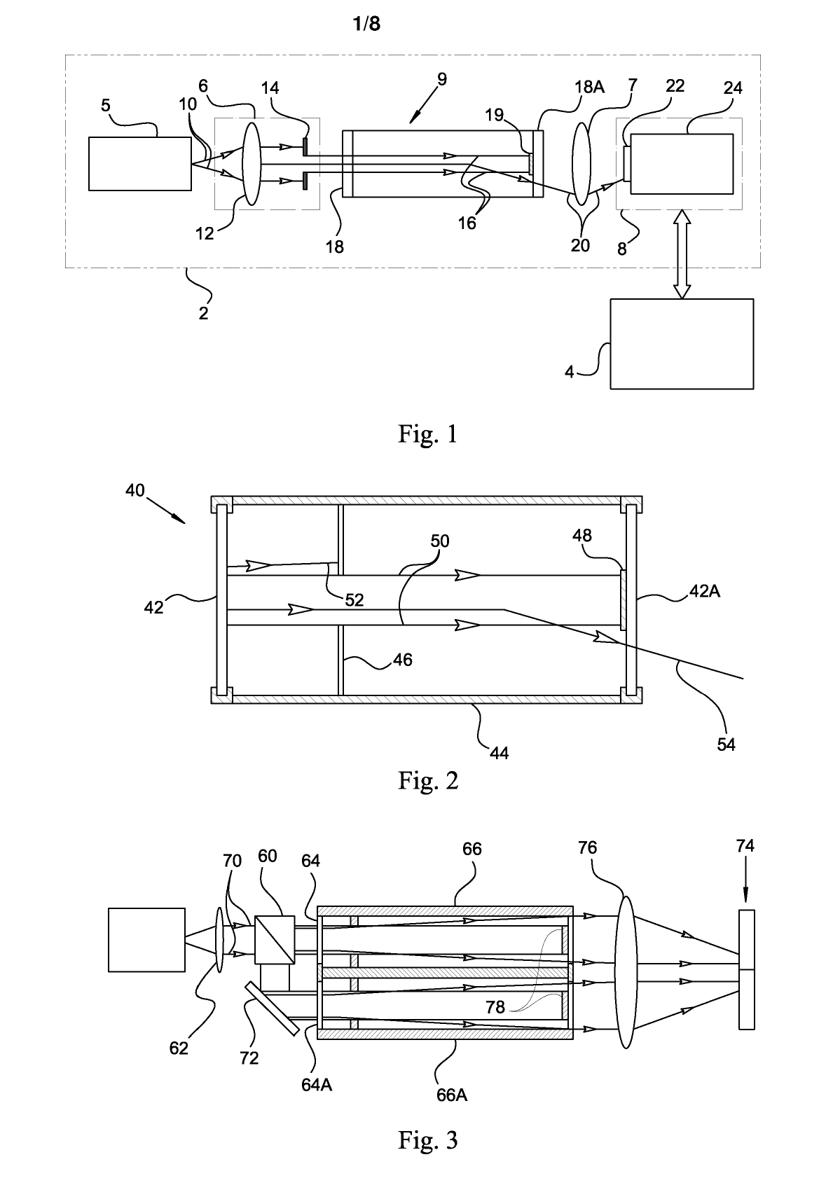

The system of the present invention provides for detecting bacteria in aqueous fluids such as water, aqueous solutions, gels, emulsions and/or s suspensions, liquid food and drinks, urine, spinal fluids, amniotic fluid and serum. In describing an embodiment of a system in accordance with the invention, reference is first made to FIG. 1, which shows a scheme of a system for detecting bacteria according to the present invention. The system consists of optical unit 2 in which samples of the examined fluid are optically tested. Processor 4 linked to the optical unit carries out measurements and calculations and activates optical unit 2. A user interface unit, not shown, linked to processor 4, typically consists of a display for presenting results of measurements and instructions to the operator and a keyboard for entering data. A power supply, not shown, powers the optical and operator interface units and the processor.

Optical Unit

Optical unit 2 contains a light source 5 producing a light beam. The light beam is collimated by collimator 6. Converging simple or compound lens 7 focuses light coming from a sample of the examined fluid sample into a receiver unit 8. A mountable cuvette unit (CU) 9 containing the sample of fluid is placed between the collimator 6 and the converging lens 7. Several alternative structural features of the CU are described below. In general the term cuvette hereinafter means a transparent vessel capable of containing a sample of the fluid and is mountable in the optical unit.

Light rays 10 represent the illuminating beam emitted by light source 5. The beam is collimated by a collimator 6 consisting of a simple or compound lens 12 and a diaphragm containing an aperture 14. A beam of collimated light represented by the rays 16 propagates through window 18 and the fluid within the cuvette. Light obscuring means 19 prevents any direct illuminating light to penetrate receiver unit 8. Light scattered in the fluid is represented by light ray 20 emerging from cuvette 9 through the unobscured segment of window 18A. Scattered light is further focused by means of converging simple or compound lens 7 on the plane of detector 22 mounted in receiver unit 8. Collimating means, not shown, provides for collimating CU 9, light obscuring means 19 and the aperture in diaphragm 14. Receiver unit 8 contains electronic circuitry 24 connected to detector 22 providing for signal amplification, sampling, digitization, intermediate data storage and timing. Data related to the measured intensity of the light collected by receiving unit 8 is further transferred to processor 4 for post-processing to be described infra.

An appropriate light source for the system may be any of the following: incandescent, gas discharge, spark and/or arc lamps; solid state devices, LEDS or lasers, or any laser source operative in the range of near infrared up to soft ultra violet. Light sources capable of emitting an illuminating power exceeding a minimal requirement specified by the sensitivity of the system are preferable. Optionally an excluding filter permitting a specific band of wavelengths to pass is disposed adjacent to collimating lens 7, and or a polarizing device is used. The detector of the invention is typically a monolithic single detector, an array of detectors and/or a monolithic detector array, operative in the wavelengths, band or bands of wavelengths, or range of wavelengths of the light source. Arrays of detectors and or monolithic detector arrays providing for measuring the intensity of scattered light over a plane are preferable.

Reference is made to FIG. 2 schematically showing a cuvette according to a preferred embodiment of the present invention. Cuvette 40 has transparent windows 42 and 42A disposed at two opposing sides of the cuvette respectively. The aperture in diaphragm 46 is disposed inside the cuvette close to window 42. Light obscuring means 48 is disposed at window 42A coaxially with diaphragm 46. The beam of collimated light is represented by rays 50. Light ray 52 scattered along its track after passing through window 42, is blocked by the diaphragm 46.

Reference is now made to FIG. 3 in which a schematic optical unit of a system according to a preferred embodiment of the present invention is shown. Beam splitting device 60 is disposed between collimating lens 62 and window 64 of cuvette 66. Two collimated beams are emitted from beam splitting device 60. The first beam propagates towards cuvette 66. The second beam which is perpendicular to the first one is reflected by reflector 72 to propagate in parallel with the first beam towards cuvette 66A. Light from each of cuvettes 66 and 66A is focused on the respective parts of dual receiver unit 74.

A system for detecting bacteria in fluids according to another embodiment of the present invention employs two light sources such as two laser diodes. This system obviates the beam splitter and the reflector described above. The lasers diodes may differ in their wavelengths. Optional obscuring means 78 shown in FIG. 3 are used in this preferred embodiment of the invention, thereby enhancement of sensitivity of fluorescence measurements is promoted.

Cuvette Unit

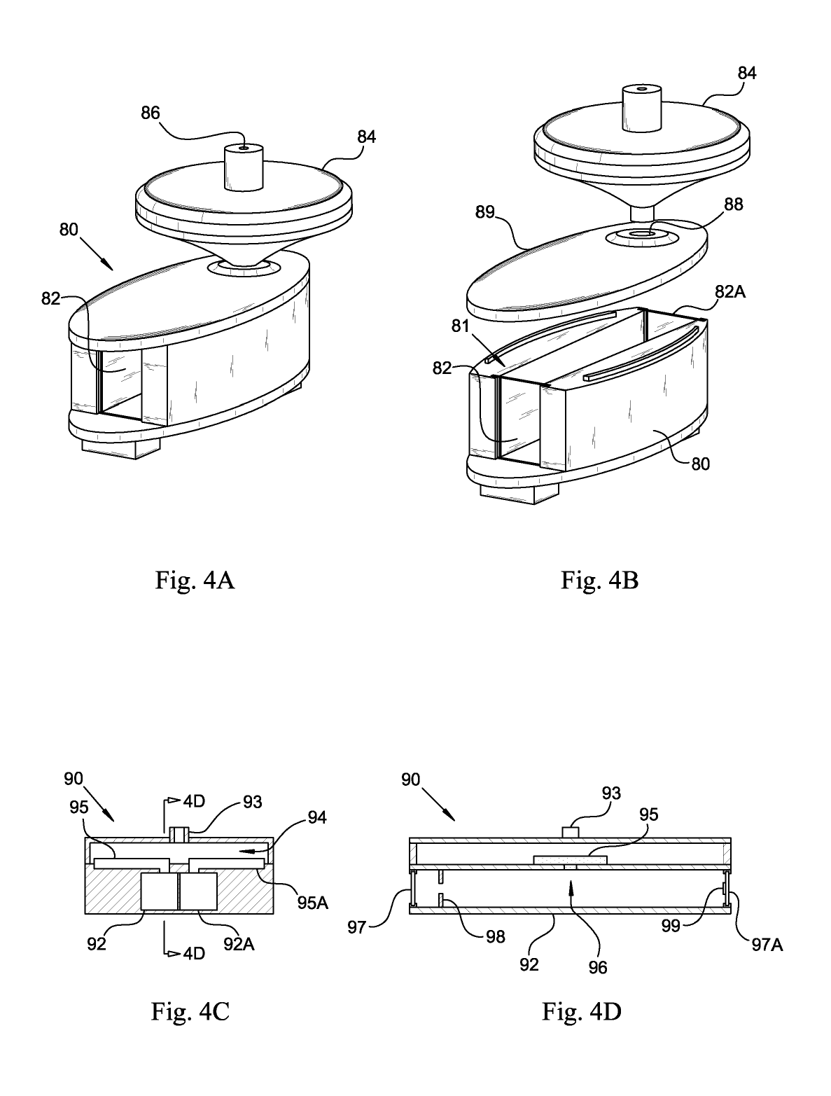

Reference is now made to FIGS. 4A and 4B showing respectively isometric and an exploded views of a cuvette unit (CU) according to a preferred embodiment of the invention correspondingly. CU 80 consists of a single cuvette disposed inside the CU housing, having window 82 disposed at a side of the CU facing the light source and parallel window 82A disposed at the opposite side. Optionally filtration means 84 having inlet aperture 86 is connected to the inlet aperture of CU 88 located at CU cover 89. A cutoff filter, not shown, rejecting particles above a specified size, is located inside filtering device 84.

The CU and body of the filtering device are typically made of materials such as plastic resins, commonly used for manufacturing disposable bottles or containers. The Cuvettes are preferably made of materials compatible with the specific fluids undergoing analysis such that they do not alter the constitution of the cuvette or conversely that the cuvette does not cause changes in the examined fluid. The windows are made, for example, of plastic typically used for manufacturing optical lenses, glass or quartz. The refraction index homogeneity of the window, namely variations in the refraction index within the window, does not exceed 0.0001. The root mean square value of the surface roughness of the windows does not exceed 1 nanometer. Windows having an optical quality of their surfaces defined by a scratch/dig number 40/20 or lower are preferable. According to the invention, windows made of plastic or glass whose width does not exceed 0.5 millimeter is a viable example. The optical homogeneity of the bulk of the window and or its surface roughness impacts the signal to noise ratio of a measured intensity of the scattered light and in turn the sensitivity of the system.

Reference is now made to FIGS. 4C-4D in which two sectional views of a CU having a dual cuvette configuration according to another embodiment of the present invention are shown respectively. Such CUs are especially suited for assaying fluids such as urine. By employing two different preprocessing procedures applied to each of the samples of fluid within each cuvette, one serves as a reference sample for the other as is further described infra. CU 90 consists of a pair of cuvettes 92 and 92A mutually attached along one of their sidewalls. CU 90 has a common inlet consisting of an aperture 93 and a space 94 located above both cuvettes for receiving the samples. Filters 95 and 95A, optionally having each a different cutoff threshold, are disposed at the inlet of each cuvette. In FIG. 4D a sectional view of this CU is shown as is indicated in FIG. 4C. Filter 95 is disposed at inlet 96. An aperture in diaphragm 98 is disposed close to window 97 and is coaxial with a light obscuring means 99 disposed on the inner surface of the opposing window 97A. Cuvette 92A is similarly furnished with windows, a filter, an aperture in diaphragm and a light obscuring means respectively.

The Assay

In general assaying includes three main steps as follows: (i) a preprocessing step; (ii) measurements step and (iii) a post processing step.

(i) Preprocessing

Urine typically contains micro particles such as salt crystals, biological macromolecules and cells, all of which have refraction indexes differing from the refraction index of the fluid. Therefore such particles may interfere with the reading of the scattering associated with the bacteria. Other biological fluids are likely to contain a multitude of interfering constituents. According to the invention the preprocessing step aims at excluding from the samples undesirable constituents, typically but not exclusively, particles of sizes larger than those of the bacteria. The preprocessing step includes: simple size exclusion, ion exchange chromatography; acidification, alkalization and/or heating; and/or sedimentation chemically and/or by cooling; and/or any combination thereof.

Reference is again made to FIGS. 4C. Filters 95 and 95A are disposed at the inlet of cuvettes 92 and 92A respectively. Their respective cutoff limits allow the passage of particles smaller than that cutoff limit. For example, in screening urine for the presence of bacteria about 5 microns in size, according to a preferred embodiment of the present invention, filter 95 is such that only particles smaller than 5 microns pass through, whereas filter 95A transmits particles sized not more than 1 micron. A sample of urine is pressurized into cuvettes 92 and 92A through aperture 93. Pressurizing is effected by means of an injector, such as a syringe. The pressurized urine passes from space 94 into both cuvettes through its corresponding filter. As a result cuvette 92 contains the urine and bacteria at a concentration level of about the original bacterial concentration level. In contrast, cuvette 92A, owing to its lower size cutoff filter, hardly contains bacteria but mainly contains other scattering particles such as crystals also present in the other cuvette.

Optionally reagents are introduced for potentially interacting with the examined fluid, either before dispensing in the CU or in the CU itself. Such reagents consist of chemical and or biochemical reactants potentially effecting chemical or biochemical reactions either with the bacteria or with other constituents of the liquid. The products of such reactions are of specific optical features that enable differentiation between bacteria and the other particulate matter. Alternatively such reagents are able to chemically or bio-chemically interact with other particles such as the biological compounds and the organic cells in order to promote their aggregation and or sedimentation.

(ii) Measurements

Subsequently, the CU containing the analyzed fluid is mounted into the optical unit. Typically, the measurements start by switching on both the light source and receiver unit. Then the intensities of light are measured at different points across the detector plane. Several measurement procedures corresponding to different post processing techniques are plausible. For example, an angular power density of the light scattered by particles contained in the fluid is measured either regardless, or as a function, of the wavelengths and/or polarization angles of the illuminating beam. The scattering profiles of samples of fluids with and without bacteria substantially differ in specific angular aspects. Such differences are enhanced when the wavelengths of the illuminating light are close to, or within, the near infrared range. Similarly, different polarization results in different scattering patterns as is induced by the bacteria.

(iii) Post Processing

Scattering is defined by azimuth and angular elevation values. The measured scattering distribution function is basically a three dimensional mapping in which the intensity of the light impinging on a plane of the detector, are represented by the level of signal of the corresponding pixels. A scattering profile is obtained by either selecting a specified azimuth, or by averaging. The scattering profile along a given azimuth resembles the measured angular distribution of the scattered light along the corresponding direction across the detector plane. Averaged scattering profiles are obtained by averaging the measured angular distribution functions over a specified range of azimuth angles.

Generally, in a post-processing step of the invention, a comparison between a calibration scale and the measured values and/or values derived from the measurements is made. This can be achieved in one of several ways. An exemplary post processing technique embodying the present invention is hereinafter described. This technique is applicable with scattering measurements that are independent of the wavelength and the polarization of the illuminating light. The angular intensity profile of a preliminary sample of urine filtered with a coarse filter and therefore suspected as containing bacteria is compared to the profile of a second sample of the same urine filtered with a fine filter. The second measured profile is calibrated or normalized by means of curve fitting, to the level of a pre-stored angular intensity profile of a sample of urine free of bacteria. Then the currently measured profile of the first sample is normalized by employing the same normalization factor. The normalized first profile is compared to a series of pre-stored scattering profiles of urine containing specific bacteria at specific bacterial concentrations. The urine is defined as infected with bacteria when the differences between the measured profile of the sample match a pre-stored trend of differences typically existing between profiles corresponding to infected and uninfected urine. The level of contamination is calculated by taking the specific bacterial concentration of the pre-stored profile that best fits the measured profile in terms of curve fitting.

A set of reference scattering profiles for the detection of bacteria in a fluid such as urine, according to a preferred embodiment of the present invention is prepared as follows. A multiplicity of germ free urine samples is collected. Each of these samples is further divided into a few distinct sub-samples that are supplemented with specific bacteria, each at a specific concentration. Angular scattering distribution is measured and recorded for each urine sample. The recorded angular distribution functions are further grouped according to the level of bacterial contamination. A reference set of standard angular scattering distribution is formed by carrying out an ensemble averaging in correspondence with each calibrated bacterial concentration level. Calibrated scattering profiles are derived from these standard angular scattering distribution functions as described above. Bacterial concentration levels are measured in colony forming units (CFU) per milliliter (CFU/ml). A single bacterium is referred hereinafter as a CFU.

Detection of bacteria according to an embodiment of the present invention is accomplished by fitting a linear combination of a calibrated scattering profile of urine supplemented with bacteria and an uninfected calibrated scattering profile to the measured scattering profile. A linear combination of calibrated scattering profiles is given by the equation: S^{c}ᵢ(x)=AᵢS^{f}(x)+BᵢS^{b}ᵢ(x),

where

x is the scattering angle;

S^{c}ᵢ(x) is the i'th outcome of the linear combination as a function of x;

S^{f}(x) is the uninfected calibrated scattering profile as a function of x;

S^{b}ᵢ(x) is the i'th calibrated scattering profile of the set of calibrated scattering profiles infected with the bacteria or a specific mixture of bacteria as a function of x, the index i indicates specific bacterial concentration;

Aᵢ and Bᵢ are parameters, the values of which are determined by curve fitting of the i'th linear combination to the measured profile. The curve fitting is accomplished by minimizing the sum of squared differences between the measured profile and the i'th linear combination of profiles at each value of x, by varying the values of the parameters Aᵢ and Bᵢ. The j'th linear combination is chosen in which the best fit is achieved. The level of bacterial infection derived for this sample is the same as of the j'th calibrated scattering profile.

The measurements procedure and post processing techniques are further described in the examples below.

### EXAMPLE 1

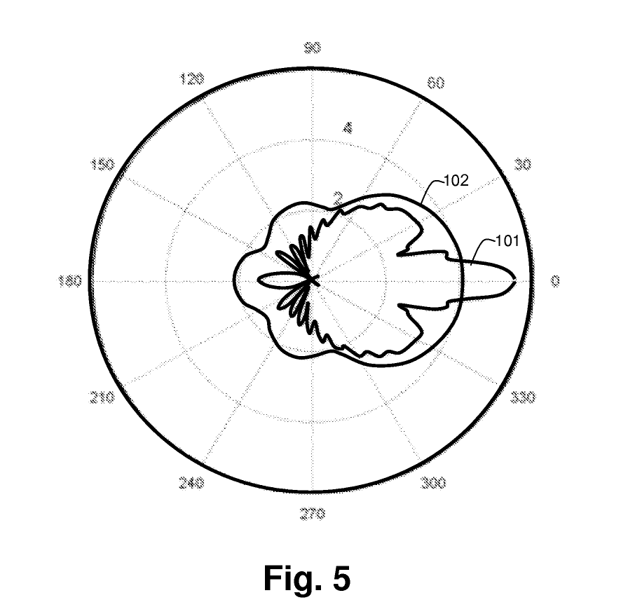

A simulated analysis of an angular scattering distribution was conducted. A synthetic model of urine was made in which 2-4 microns diameter spheres having the same dielectric constant as that of bacteria were included. Salt particles are represented by spheres having a radius that is smaller than one micron and a matching dielectric constant. Calculations are based on the scattering Mie theory [H. C. van de Hulst. “Light scattering by small particles”, John Wiley & Sons publishing, NY, 1957]. Reference is now made to FIG. 5 showing a plot of the simulated angular scattering distribution function of suspensions of the two kinds of particles described above. Curve 101 represents the intensity of light scattered by the suspension of particles representing bacteria. Curve 102 corresponds to the intensity of light scattered by the small particle representing crystalline salt particles in urine. The intensity is shown in a logarithmic scale and is represented in polar coordinates versus the scattering angle. It is demonstrated that larger particles scatter mostly at small scattering angles, while scattering from smaller particles has a considerably broader angular distribution, which is of a slightly varying intensity at scattering angles within a considerable angular range centered at 0⁰.

### EXAMPLE 2

Measurements described below were taken by employing a system in which the light source is a laser diode of a specific wavelength and intensity and an CU having one cuvette. An elaborated model of urine containing bacteria was prepared and a scaled geometry of the system described in FIG. 1 to which reference is again made was employed as follows:
1) The dimensions of bacteria are defined in the literature.
2) The bacteria are randomly dispersed in the illuminated volume of the sample of fluid.
3) The light source of the model is a laser diode having the same features as the light source of the system employed in the actual measurements.
4) The angular intensities of scattered light for each single bacterium were calculated using the above mentioned Mie scattering model.
5) Scattered light rays are optically traced using a model of the optical unit employed for the actual measurements.
6) The power density of the scattered beam is calculated at the plane of the detector.

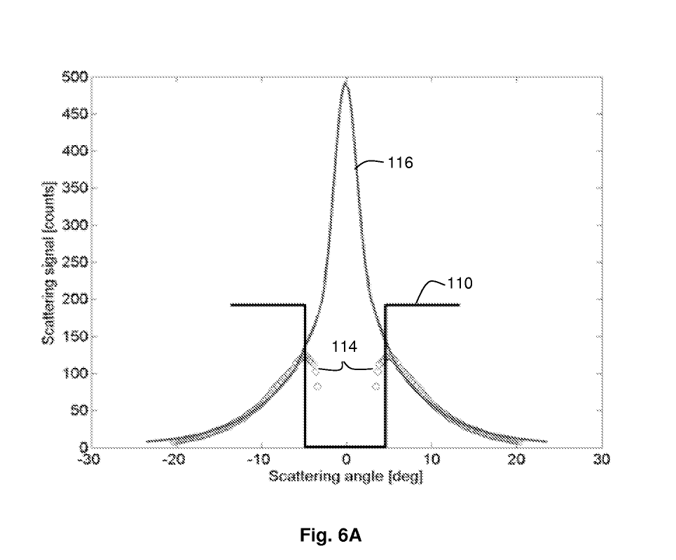

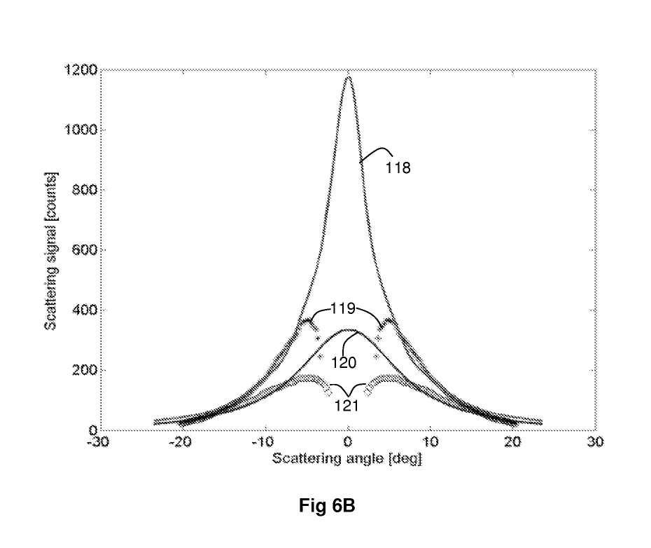

Reference is made to FIG. 6A showing plots of intensities of scattered light versus scattering angles of two typical samples of urine. Curve 110 represents synthetic transmittance of the cuvette considering the light reflector. Curve 114 represents measured scattering profile of a typical urine sample infected with E. coli at a bacterial concentration of 10⁴ CFU/ml. Curve 116 represents the simulated profile of same urine sample of which its total intensity is normalized to that of the measured profile.

Reference is made to FIG. 6B in which a comparison between measured and simulated angular distributions of scattering intensity employing urine supplemented with bacteria are shown correspondingly. Measurements were carried out employing the same optical unit and CUs of a single cuvette configuration as is described in example 1 above. The simulated scattering intensities were calculated for bacteria statistically distributed within 2-4 microns in accordance with the elaborated model. The salt particles of the model are statistically distributed within 0-1.5 micron range conforming to the measured data. Curves 118 and 119 represent simulated and measured signal intensities respectively as a function of the scattering angle employing urine samples with bacteria. Curves 120 and 121 show the simulated and measured scattering profiles of the urine samples without bacteria respectively.

### EXAMPLE 3

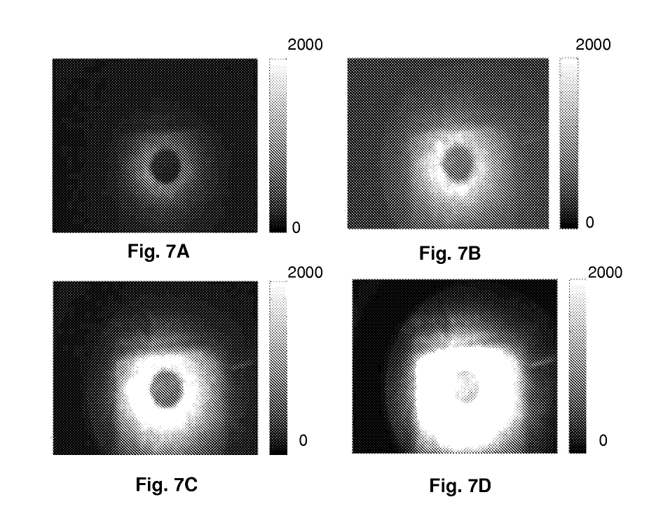

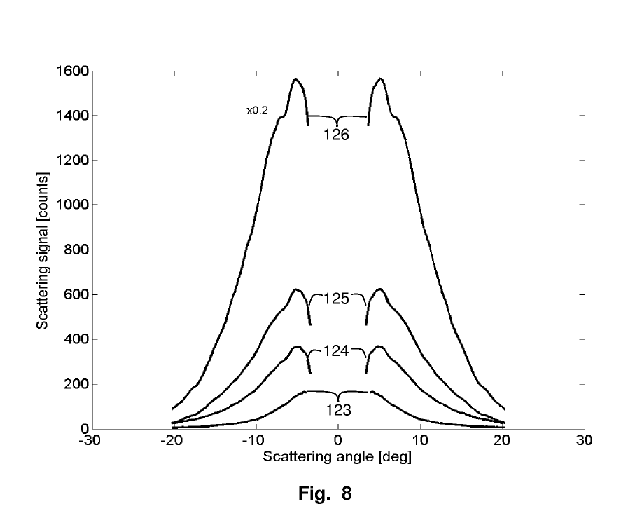

Light scattering measurements were conducted by employing the same optical unit and CUs as is described in example 2 above and several urine samples supplemented with bacteria at different bacterial concentration levels. Bacterial concentration levels were independently calibrated by employing incubation as in the prior art. Reference is now made to FIGS. 7A-7D in which are shown typical angular scattering distribution functions of infected urine at bacterial concentration levels of 10³, 10⁴, 10⁵, and 10⁶ CFU/ml respectively. Scattering profiles were derived from these typical distribution functions by averaging over most of the azimuth range. In FIG. 8 a graph comparing the scattering profiles corresponding to the measured angular distribution functions of FIGS. 7A-7D is shown. Plots 123, 124, 125 and 126 represent these scattering profiles of infected urine at the same bacterial concentration levels as FIGS. 7A-7D respectively.

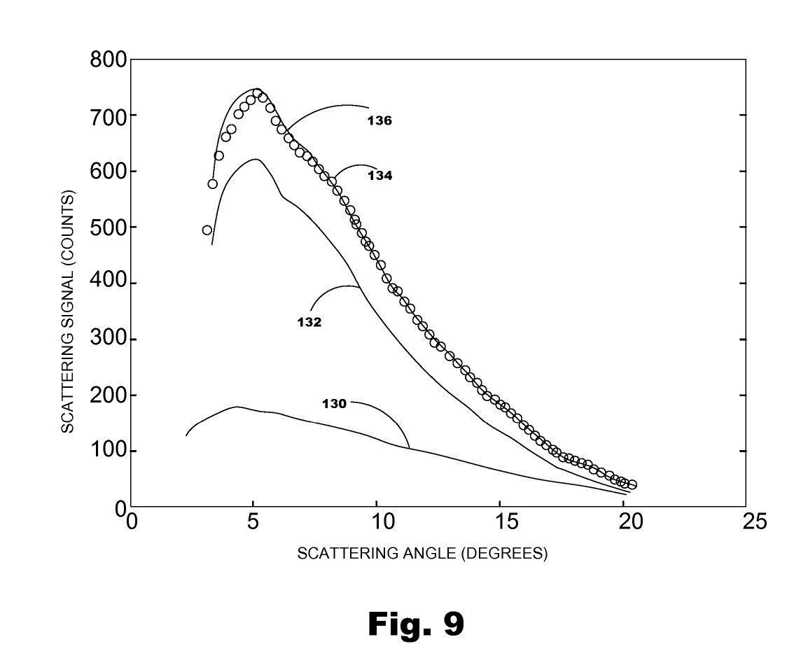

A typical urine sample known to be contaminated with e-coli was tested for presence of bacteria by employing the same optical measuring device and CUs of single cuvette configuration as is described above. Scattering profile was measured and the detection of bacteria according to the preferred embodiment of the present invention as is herein described above has been conducted. Reference is now made to FIG. 9 in which two calibrated scattering profiles of a set of calibrated profiles and the measured and fitted scattering profiles of this urine sample are correspondingly shown. Curve 130 represents the calibrated scattering profile of uninfected urine. Curve 132 represents one of the calibrated scattering profiles of infected urine (cleared of any salt particles) at a specific bacterial concentration level. Curve 134 represents the scattering profile fitted to the examined sample. Curve 136 represents the measured scattering profile of this sample under test. A considerably high level of matching is demonstrated over a significant range of scattering angles. The detected level of bacterial concentration in this examined sample deviated from the reference level by a few percent.

1. A method for detecting bacteria in a fluid comprising the steps of:
filtering at least one sample of said fluid thereby excluding particles larger than said bacteria;
illuminating said at least one sample of fluid using a collimated light beam;
measuring the intensity of light scattered by said at least one sample of fluid at least at one point;
comparing said scattered light to a calibration scale, and wherein said fluid has not been incubated prior to said filtering.

2. A method as in claim 1, further comprising
filtering a second sample of said fluid thereby excluding particles larger than a predefined limit smaller than said bacteria;
illuminating said second sample of fluid using a collimated light beam, and
measuring the intensity of light scattered by said second sample of fluid at least at one point, and
comparing said scattered light to a calibration scale.

3. A method as in claim 1, further comprising associating a scattering profile with said measured intensity.

4. A method as in claim 2, further comprising associating a scattering profile with said measured intensity.

5. A method as in claim 3, further comprising matching to said associated scattering profile any item selected from a list of items consisting of pre-stored calibrated scattering profiles and linear combinations of pre-stored calibrated scattering profiles.

6. A method as in claim 1, further comprising polarising said collimated light beam.

7. A method as in claim 1, wherein said measuring is carried out regarding at least at one specific wavelength.

8. A method as in claim 1, wherein said illuminating is effected by at least one laser diode.

9. A cuvette unit (CU) comprising at least one cuvette, wherein said at least one cuvette comprises at least one window transparent at least to light of specified range of wavelengths, wherein the root mean square (RMS) value of a surface roughness of said window does not exceed one nanometre, and wherein changes in the values of the refraction index within said window do not exceed 0.0001.

10. A cuvette unit (CU) comprising at least one cuvette, wherein said at least one cuvette comprises at least one window transparent at least to light of specified range of wavelengths, wherein the width of said window does not exceed 500 microns.

11. A CU as in claim 9, wherein a light obscuring means is disposed at said at least one window.

12. A CU as in claim 10, wherein a light obscuring means is disposed at said at least one window.

13. A CU as in claim 9, wherein an aperture in a diaphragm is disposed in said at least one cuvette.

14. A CU as in claim 10, wherein an aperture in a diaphragm is disposed in said at least one cuvette.

15. A CU as in claim 13 wherein an aperture is disposed in a diaphragm in said at least one cuvette.

16. A CU as in claim 14, wherein an aperture in a diaphragm is disposed in said at least one cuvette.
